(19) United States
(12) Patent Application Publication
(10) Pub. No.: US 2010/0135885 A1
(43) Pub. Date: Jun. 3, 2010

(54) System and Method for Removing Organic Compounds from Exhaust Gases

(76) Inventors: Ronald G. Patterson, San Diego, CA (US); Andrew J. Olds, San Diego, CA (US)

Correspondence Address: Delaney IP, P.O. Box 9542, Rancho Santa Fe, CA, 92067, US

(21) Appl. No.: 12/325,791

(22) Filed: Dec. 1, 2008

(51) Int. Cl. B01D 53/44; B01J 19/00

(52) U.S. Cl. 423/245.2; 422/171

(57) ABSTRACT

A system removes ethanol and other organic carbons from fermentation exhaust gases. Structurally, the system includes a first scrubber with top and bottom ends. Further, the system includes a second scrubber with a top end and with a bottom end in fluid communication with the first scrubber's top end. During operation, exhaust gases are introduced into the bottom end of the first scrubber. Further, a light alcohol solvent is flowed down from the top end to the bottom end of the first scrubber. As the solvent contacts the exhaust gases, it absorbs the other organic carbons. Thereafter, the exhaust gases enter the second scrubber's bottom end. At the second scrubber's top end, water is introduced and falls into contact with the exhaust gases, absorbing the ethanol. In this manner, ethanol and other organic carbons are removed from the exhaust gases solely through absorption by solvents.

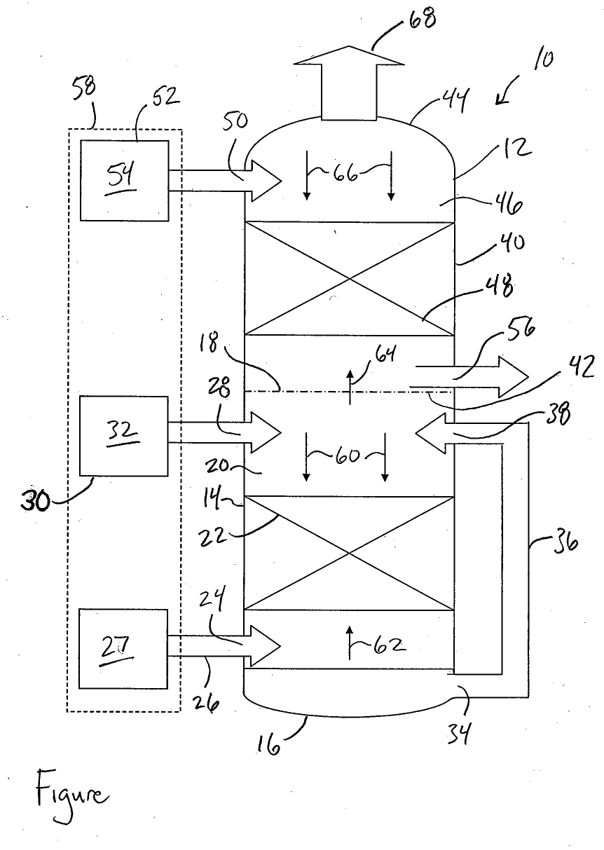

### FIELD OF THE INVENTION

The present invention pertains generally to an air pollution abatement system. More particularly, the present invention pertains to a scrubbing system that recovers total organic carbons from an exhaust gas stream. The present invention is particularly, but not exclusively, useful as total organic carbon recovery scrubbing system that utilizes light alcohol solvent in a first scrubber and water solvent in a second scrubber.

### BACKGROUND OF THE INVENTION

Within many industries, there is a demand for reducing the levels of total organic carbon (TOC) in exhaust gases. For instance, fermentation plants, distilleries, and ethanol plants may each produce exhaust gases having TOC levels above permitted limits. For fermentation procedures such as bread baking, the exhaust gases are high in TOC, including high percentages of ethanol. Ethanol is dangerous because it is a known precursor of ozone. Further, ground-level ozone in concentrations of one part per million in air may cause headaches and irritations of the upper respiratory tract. Therefore, the Unites States' Environmental Protection Agency has required that large commercial baking ovens have ethanol abatement systems in order to reduce the amount of ethanol exhausted from the ovens to the environment and, thereby, reduce atmospheric ozone concentrations.

While ethanol is somewhat easily absorbed by abatement systems such as wet scrubbers, TOC in exhaust gases also include other organic carbon compounds including, but not limited to, methanol, ethyl acetate, acetone, acrolein, acetaldehyde, and other organic acids, aldehydes, and ketones. For non-volatile or weakly volatile polar organics such as ketones and aldehydes, removal from exhaust gases typically requires chemical transformation (via reduction for the aldehydes) or thermal oxidization. As a result, plants often use thermal oxidizers to destroy organic carbon compounds to meet environmental air discharge requirements. The thermal oxidizers may use direct incineration or catalytic incineration. For direct incineration, large amounts of energy are required to raise the process exhaust-gas temperatures above 1400° F. as required for effective removal of the compounds. While catalytic incineration is able to achieve the same removal at about one-half this gas temperature with less energy, it does require regular replacement of the catalyst. In either case, thermal oxidizers are inefficient and relatively expensive.

In light of the above, it is an object of the present invention to provide a system and method for treating exhaust gases to reduce their TOC to acceptable levels. It is another object of the present invention to provide a TOC abatement system with two scrubbers in series: a first scrubber utilizing a light alcohol solvent and a second scrubber utilizing water as solvent. Another object of the present invention is to provide a system for first reducing levels of non-ethanol TOC in exhaust gases before then removing ethanol from the exhaust gases. Still another object of the present invention is to reduce the level of TOC in exhaust gases without using thermal oxidation or chemical transformation. Yet another object of the present invention is to provide a system for removing organic compounds from exhaust gases and a method for operating the system which are easy to use, relatively simple to implement, and comparatively cost effective.

### SUMMARY OF THE INVENTION

The present invention is directed to a system for removing gaseous ethanol and other organic carbons from fermentation exhaust gases. Importantly, the system is able to reduce TOC in the exhaust gases to acceptable levels without requiring thermal oxidation or chemical transformation. Specifically, the system includes a first scrubber connected in series with a second scrubber. During use, the system removes the other organic carbons from the exhaust gases in the first scrubber with a light alcohol solvent, i.e., ethanol solvent or methanol solvent. Thereafter, ethanol in the exhaust gases is removed by the second scrubber utilizing water as the solvent.

Structurally, the first scrubber has a bottom end and a top end. At the bottom end, a conduit is mounted for feeding the fermentation exhaust gases into the first scrubber. Also, a source of a light alcohol solvent is connected to the top end of the first scrubber to cause the light alcohol solvent to fall from the top end to the bottom end. Herein, light alcohol solvent refers to a solvent comprising ethanol, aqueous ethanol, methanol or aqueous methanol. For the system, the light alcohol solvent preferably is concentrated, with a concentration greater than 10% alcohol. For certain embodiments, the ethanol solvent may be distilled alcohol (95% alcohol) or pure alcohol (100% alcohol). Further, the light alcohol solvent may be at ambient temperature or cooled. As the light alcohol solvent falls, it contacts the rising exhaust gases and absorbs the other organic carbons.

After exiting the first scrubber, the exhaust gases enter the second scrubber. At this point, the exhaust gases have been substantially depleted of the other organic carbons by the light alcohol solvent. Structurally, the second scrubber includes a bottom end, where the exhaust gases enter, and a top end. Near the top end, a source of water is connected to the second stage to cause water to fall to the bottom end of the second scrubber. As it falls, the water absorbs the ethanol from the exhaust gases. By the time the exhaust gases reach the top end and exit the second scrubber, substantially all of the ethanol and the other organic carbons have been removed from the exhaust gases. At the least, sufficient amounts of ethanol and the other organic carbons have been removed to meet TOC guidelines.

### BRIEF DESCRIPTION OF THE DRAWING

The novel features of this invention, as well as the invention itself, both as to its structure and its operation, will be best understood from the accompanying FIGURE, taken in conjunction with the accompanying description, in which similar reference characters refer to similar parts, and in which the FIGURE is a plan view of a system for removing ethanol and other organic carbons from fermentation exhaust gases.

### DESCRIPTION OF THE PREFERRED EMBODIMENTS

Referring to the FIGURE, a scrubbing system for removing ethanol and other organic carbons from fermentation exhaust gases is shown and generally designated 10. As shown in the FIGURE, the system 10 comprises a first scrubber 14 having a bottom end 16 and a top end 18 and enclosing a chamber 20. Within the chamber 20 between the ends 16, 18 is a countercurrent vapor-liquid contact mechanism 22. For the system, the mechanism 22 may be tray-type, packed bed, direct spray or other arrangement for providing countercurrent vapor-liquid contact.

As shown in the FIGURE, an input port 24 is provided adjacent the bottom end 16 of the first stage 14. Further, the input port 24 is in fluid communication with a conduit 26 for introducing exhaust gases 27 into the first stage 14. Also, an input port 28 is positioned adjacent the top end 18 of the first stage 14, and is connected to a supply 30 of light alcohol solvent 32. As shown, an outlet port 34 is provided at the bottom end 16 of the first stage 14, and is connected via a recycling conduit 36 to an input port 38 at the top end 18 of the first stage 14.

In the FIGURE, it can be seen that the system 10 also includes a second scrubber 40. As shown, the second stage 40 has a bottom end 42 and a top end 44 and encloses a chamber 46. Within the chamber 46, the second stage 40 includes a countercurrent vapor-liquid contact mechanism 48, such as a tray-type, packed bed, direct spray or other arrangement for providing countercurrent vapor-liquid contact. For purposes of the system 10, the bottom end 42 of the second stage 40 is in fluid communication with the top end 18 of the first stage 14. Further, an input port 50 is located adjacent the top end 44 of the second stage 40 and is in communication with a source 52 of water 54. Also, an outlet port 56 is positioned at the bottom end 42 of the second stage 40.

As indicated in phantom in the FIGURE, the exhaust gases 27, light alcohol solvent 32 and water 54 may all be provided from an industrial facility 58 as components of its normal operations. Such a facility 58 may be a fermentation plant, a distillery, an ethanol plant, or the like.

During operation of the system 10, exhaust gases 27 including gaseous ethanol and other organic carbons are introduced into the chamber 20 of the first stage 14 via conduit 24. At the same time, the light alcohol solvent 32 is added to the chamber 20 of the first stage 14 from the supply 30. In certain embodiments, the light alcohol solvent 32 may be pure ethanol or methanol (100%), distilled (95% ethanol or methanol), or concentrated (greater than 10% ethanol or methanol). Further, the light alcohol solvent 32 may be at ambient temperature or cooled to about 40° F. Generally, the solvent will have a temperature in the range of 40-100° F. In certain embodiments, a temperature decrease of ten degrees within this range can improve scrubber efficiency by 200-2500%.

As the light alcohol solvent 32 falls (indicated by arrows 60) due to gravity, it contacts the rising exhaust gases 27 (indicated by arrow 62) in the liquid-vapor contact mechanism 22. During contact between the light alcohol solvent 32 and the exhaust gases 27, the light alcohol solvent 32 absorbs the other organic carbon compounds from the exhaust gases 27. After the light alcohol solvent 32 containing the absorbed organic carbon compounds reaches the bottom end 16 of the first stage 14, it, or a portion of it, may be recycled to the top end 18 via the recycling conduit 36 and injected into the chamber 20 with minimal loss of energy or product recovery.

In certain embodiments, when the exhaust gases 27 reach the top end 18 of the first stage 14, they are substantially void of the other organic carbon compounds. Specifically, the exhaust gases contain less than 1.0% other organic carbon compounds. Preferably, the exhaust gases contain less than 0.1% other organic carbon compounds. Most preferably, the exhaust gases contain less than 0.01% other organic carbon compounds. These results are made possible due to the ability of the light alcohol solvent 32 to absorb organic carbon compounds including, but not limited to, methanol, ethyl acetate, acetone, acrolein, acetaldehyde, and other organic acids, aldehydes, and ketones. Importantly, the use of light alcohol solvent 32 greatly increases the absorption of the other organic carbon compounds. For instance, for ethanol solvent as compared to water as solvent, the solubility of ethyl acetate increases by a factor of 280, the solubility of acetaldehyde increases by a factor of 12, the solubility of acetone increases by a factor of 3, and the solubility of methanol increases by a factor of 2, using experimental values for Wilsons binary interaction coefficients. As a result of the noted increase in solubility, the corresponding height of the first scrubber 14 required to produce an equivalent exhaust organic concentration of the other organic carbon compounds is decreased. When using the ethanol solvent, the concentration of gaseous ethanol exiting the first scrubber is governed by the dew point of ethanol at the operating temperature of the first stage 14.

Therefore, the organic carbon content of the exhaust gases 27 exiting the first stage 14 and entering the bottom end 42 of the second stage 40 (indicated by arrow 64) is substantially limited to gaseous ethanol. At the top end 44 of the second stage 40, water 54 is introduced into the chamber 46 and falls toward the bottom end 42 (as indicated by arrows 66). When the water 66 contacts the rising exhaust gases 64 in the liquid-vapor contact mechanism 48, the water 66 absorbs the gaseous ethanol from the exhaust gases 64. Specifically, the water absorbs the ethanol below its dew point to recover the ethanol. As a result, the exhaust gases (indicated by box arrow 68) exiting the second stage 40 meet an acceptable environmental air discharge level.

In the FIGURE, the scrubbers 14, 40 are illustrated as being formed by a single two-stage wet scrubber 12. However, this arrangement is only exemplary and is not required by the invention. For instance, the first and second scrubbers 14, 40 may be independent structures, with the bottom end 42 of the second scrubber 40 being connected downstream from the top end 18 of the first scrubber 14.

As a result of the structure and cooperation of structure of the system 10 and unlike current systems, non-volatile or weakly volatile polar organics such as ketones and aldehydes are effectively removed from the exhaust gases 27 without resorting to chemical transformation (via reduction for the aldehydes) or to thermal oxidization. This is due to the dramatic increase in the efficiency of removal via absorption for those particularly difficult species. Typically, plants use thermal oxidizers to destroy any residual organic compounds to meet their environmental air discharge requirements.

While the particular System and Method for Removing Organic Compounds from Exhaust Gases as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A system for removing gaseous ethanol and other organic carbons from fermentation exhaust gases comprising:
a first scrubber having a bottom end and a top end;
a conduit for feeding the fermentation exhaust gases into the bottom end;
a source of light alcohol solvent connected to the top end to cause the light alcohol solvent to fall from the top end to the bottom end while absorbing the other organic carbons from the exhaust gases;
a second scrubber having a bottom end and a top end, wherein the bottom end of the second scrubber receives the exhaust gases from the top end of the first scrubber; and
a source of water connected to the top end of the second scrubber to cause water to fall from the top end of the second scrubber to the bottom end of the second scrubber while absorbing the gaseous ethanol from the exhaust gases.

2. A system as recited in claim 1 wherein the light alcohol solvent is ethanol solvent and has a concentration greater than 10% ethanol.

3. A system as recited in claim 2 wherein the ethanol solvent has a concentration of 95% ethanol.

4. A system as recited in claim 2 wherein the ethanol solvent has a concentration of 100% ethanol.

5. A system as recited in claim 1 wherein the light alcohol solvent is methanol solvent and has a concentration greater than 10% methanol.

6. A system as recited in claim 1 wherein the light alcohol solvent is cooled to a temperature of about 40° F.

7. A system as recited in claim 1 further comprising a fluid connection from the bottom end of the first scrubber to the top end of the first scrubber to recycle the light alcohol solvent.

8. A system as recited in claim 1 wherein the exhaust gases exiting the top end of the second scrubber comprise less than 0.1% gaseous ethanol and less than 0.1% other organic compounds.

9. A system as recited in claim 1 wherein the other organic carbons are selected from the group consisting of organic acids, aldehydes, and ketones.

10. A system as recited in claim 1 wherein 0.1% of the other organic carbons are removed from the exhaust gases by the light alcohol solvent.

11. A system as recited in claim 1 wherein the first scrubber and the second scrubber are housed together as a first stage and second stage in a two-stage scrubber.

12. A system for removing ethanol and other organic carbons from exhaust gases comprising:
a first scrubber having a bottom end for receiving the exhaust gases and a top end for receiving a light alcohol solvent, wherein the light alcohol solvent absorbs the other organic carbons from the exhaust gases while falling to the bottom end; and
a second scrubber having a bottom end for receiving the exhaust gases from the first scrubber and a top end for receiving water, wherein the water absorbs the ethanol from the exhaust gases while falling to the bottom end of the second scrubber.

13. A system as recited in claim 12 wherein the first scrubber recycles the light alcohol solvent from the bottom end to the top end.

14. A system as recited in claim 12 wherein the exhaust gases exiting the top end of the second scrubber comprise less than 0.01% gaseous ethanol and less than 0.01% other organic compounds.

15. A system as recited in claim 12 wherein the exhaust gases exiting the first scrubber are substantially void of the other organic carbons.

16. A system as recited in claim 12 wherein the other organic carbons are selected from the group consisting of organic acids, aldehydes, and ketones.

17. A method for removing gaseous ethanol and other organic carbons from fermentation exhaust gases comprising the steps of:
providing a first scrubber having a bottom end and a top end, and a second scrubber having a bottom end and a top end, with the top end of the first scrubber in fluid communication with the bottom end of the second scrubber;
introducing the fermentation exhaust gases into the bottom end of the first scrubber;
flowing a light alcohol solvent from the top end of the first scrubber to the bottom end of the first scrubber to absorb the other organic carbons from the exhaust gases;
passing the exhaust gases from the top end of the first scrubber to the bottom end of the second scrubber; and
running water from the top end of the second scrubber to the bottom end of the second scrubber to absorb the gaseous ethanol from the exhaust gases.

18. A method as recited in claim 17 further comprising the step of recycling the light alcohol solvent from the bottom end of the first scrubber to the top end of the first scrubber.

19. A method as recited in claim 17 wherein the exhaust gases exiting the top end of the second scrubber comprise less than 0.1% gaseous ethanol and less than 0.1% other organic compounds.

20. A method as recited in claim 17 wherein the other organic carbons are selected from the group consisting of organic acids, aldehydes, and ketones.
